(19) United States
(12) Patent Application Publication
(10) Pub. No.: US 2013/0138576 A1
(43) Pub. Date: May 30, 2013

(54) SYSTEMS AND METHODS FOR IMPLEMENTING A DEFINED MATURITY EQUITY

(71) Applicant: Jack Xu, Hong Kong (CN)

(72) Inventor: Jack Xu, Hong Kong (CN)

(21) Appl. No.: 13/306,064

(22) Filed: Nov. 29, 2011

(51) Int. Cl. G06Q 40/06

(52) U.S. Cl. 705/36 R

(57) ABSTRACT

The invention relates to investment vehicles and supporting systems and methods for implementing and determining the value of a defined maturity equity. In one aspect, the invention includes identifying investment opportunities that represent underlying equity interests in ongoing businesses and selecting one or more of the underlying equities as a basis for a defined maturity equity investment to be issued on an issuance date and to mature on a particular maturity date. Each maturity date represents a future date on which the respective defined maturity equity investment may be redeemed for a respective redemption value. A redemption value may be calculated for the defined maturity equity investment based on operational results of the ongoing business between the issuance date and the maturity date of the defined maturity equity.

### TECHNICAL FIELD

The present invention relates generally to investing, and more particularly, to an investment vehicle that includes equity ownership rights to an underlying entity having a defined maturity date.

### BACKGROUND

Traditionally, equities or stock are considered “perpetual” securities in which the equity holder owns a claim on the underlying assets of the associated company for as long as the holder owns the equity share. In the case of equity, the claim is on all the assets possessed by the company, at present and in the future, after claims held by bond holders are satisfied. However, unlike bonds, equity securities do not have a set date upon which the value of the equity rights are forced to be paid to the equity holder, unless the company fails and is forced into liquidation. Under normal circumstance though, a company is presumed to continue operating indefinitely, so even though the value of the equity is presumably increasing over time, an equity investor cannot redeem his position and potentially profit from his investment unless he sells the equity outright at the current market price. However, there is a key difference between the current value of an equity claim (i.e., what a share of the company is worth on that day) and the market price, as the market price attempts to consider both the current value of the equity claim and its value in the future.

There are shortcomings posed by the perpetual nature of traditional equity security investing. The primary shortcoming is the almost meaninglessness of the assessment of its future value through a current price. Price, in theory, is the current equivalent value of a value on a future date. However, when such future dates are not stipulated, assessing value becomes an art form, rather than a structured analysis of a security's underlying value. Whatever an analyst claims to be the fair value of a company today cannot be accurately verified because on any given date the analyst can proclaim that its fair value will be realized in the future. Despite such a lack of logical foundations, financial professionals continue to suggest various theories to justify the existence of a theoretical or fair value price.

The most widely utilized method is the so-called “discounted cash flow” or “DCF” method. In essence, DCF avoids the infinite value problem by splitting the value generated by a company into two parts. The first part is an arbitrarily chosen finite time horizon, normally 10-15 years depending on the industry, sector and the analyst. Fundamental analysis is then performed based on the operation of the company to forecast the total value generated by the company during that finite time period. The second part attempts to place a value of the company during the remaining infinite time horizon. Here, analysts must determine a finite value, or in mathematical terms, force an infinite series to converge using subjective methods. For example, analysts pick a perpetual growth rate of the company that is lower than the perpetual discount rate. By choosing a smaller growth rate than discount rate, analysts manage to make the infinite series converge to a finite number and “devise” a value for the remaining infinite time. The price of the equity is then stated as the sum of the two parts.

There are numerous deficiencies with such methodology. First, the value from the second part is artificial, subjective and arbitrary. For example, a perpetual growth rate of around 4% is commonly used by analysts, yet there is no specific justification for using such a value. To amplify the problem, even small variances in the perpetual growth rate (e.g., changing the rate from 4% to 4.5% or 3.5%), results in large changes to the final valuation. Clearly, conventional methods have too much sensitivity to errors from an artificially derived input variable. Furthermore, although the final valuation of a company is the sum of the two components described above, the value derived from the second component typically comprises more than half (around 60%-70%), of the final valuation.

Some may suggest that this theoretical price is irrelevant since the market price of an equity security is determined by the balancing of buying and selling of that security in an open market. Still, this does not address the question that the market price has a different meaning than the value of the underlying shareholder's equity. By graphing the stock price of a public company against the company's retained earnings during the same period, it is apparent that over the past twenty or so years, the two quantities are not strongly correlated for most public companies. It is no surprise, then, that the current market price is not a reliable predictor of a company's value creation. For any prediction to be meaningful, a finite time horizon is needed such that at the end of the period the prediction can be validated or disproved.

An equity investor who is highly knowledgeable about a certain industry and who is capable of making accurate analysis on certain companies, by definition, can produce such analysis only for a finite time horizon. Typically, the shorter the horizon, the more accurate the analysis is. Although it may vary between industries, no one can quite reliably analyze the operation of a company beyond 15 or 20 years. However, as the DCF method has suggested, the overall equity price of a company can overwhelm the value derived for any finite time horizon. When the market equity price is significantly higher than, or is even multiples of, the value the investor can forecast, he has no means to utilize his analysis. Many believe that this inability has contributed greatly to the decline of the fundamental approach of investing.

What is needed, therefore, is an accurately valued investment vehicle and systems for offering and redeeming such investments that is tied directly to a company's performance over a fixed period of time.

### SUMMARY OF THE INVENTION

The present invention provides techniques, systems and investment vehicles based on multiple equity products and corresponding prices of underlying equity investments, each having a known maturity date with differing finite time horizons, referred to herein as a Defined Maturity Equity, or “DME.” Using a DME, an investor may invest in an equity based on his analysis and the forecast of the operation of the company over some fixed time horizon based on observable operational results for that company during that time horizon.

Generally the processing of a DME includes three main components—issuance, distribution, and redemption. For example, shares of the underlying equity is purchased in the market before the DME issuance and deposited with a trustee or custodian as collateral. A corresponding number of DME shares, normally equal to the shares of the underlying equity, may then be issued having a fixed maturity date. During the issuance period of the DME (issue date through redemption), all the rights attached to the underlying equity are transferred to the DME holder, including, for example, the right to receive dividends, with the exception that the DME holder does not have the ability to liquidate the shares of the underlying equity. Finally, on the maturity date, the shares of the collateral equity are liquidated in the public market (the liquidation may start before the maturity date for practical reasons) and the proceeds are applied to pay the DME holder the redemption value. The redemption value of the DME is determined based on the term and the financial results of the company up to the maturity date. In some embodiments, the DME holder receives the minimum of the redemption value and the amount of proceeds obtained from the collateral liquidation. In other instances, however, certain other investors may provide the shortfall between the liquidation proceeds and the computed redemption value.

Therefore, in a first aspect, a computerized method for pricing the redemption value of an investment vehicle includes identifying various investment opportunities, each being represented by an underlying equity ownership interest in an ongoing business and selecting one or more of the underlying equities as a basis for classes of defined maturity equity investments (DMEs). The DMEs are structured such that each class of the defined maturity equity investment holds equity ownership rights to the selected underlying equities during the period between the issuance date and the maturity date, and each of the classes of defined maturity equity investments has an issuance date and a maturity date on which the respective defined maturity equity investments may be redeemed for a respective redemption value. A set of allocation and redemption processing rules are retrieved for calculating allocation of disbursements to each class of the defined maturity equity investment generated by the underlying equities and the respective redemption values of each class of the defined maturity equity investment. The rules are executed on a processor, and in doing so calculate disbursement amounts for each class of the defined maturity equity investments and the redemption value for the defined maturity equity investments based on operational results between the issuance date and the respective maturity date of the defined maturity equity of the ongoing businesses associated with the respective underlying equities. The allocation rules formalize the transfer of the benefits and rights typically afforded to the equity owners of the underlying business to each class of DME investment. These benefits may include non-cash benefits, for example, voting rights, and/or share subscription priority.

In some embodiments, the underlying equity interest in the ongoing business may be, for example, common stock traded on an open marketplace. The respective maturity dates may be fixed dates subsequent to the issuance date, or, in other instances, dates based on a known time horizon. In some cases multiple DME classes can be issued simultaneously with different fixed maturity dates, each maturing at different time horizons. The time horizons may be of any duration, but in specific embodiments include one, two, five, ten and/or twenty year horizons. The dates may be selected based on a calendar (e.g., end of quarter, end of year) or dates on which the underlying business releases financial results. Notwithstanding the fixed maturity date, early redemption events can be defined in some instances under which the maturity date is accelerated.

Instructions may be received to purchase one or more of the defined maturity equity investments, and in response thereto, shares in the ongoing business are purchased and deposited with the trustee or custodian. The number of defined maturity equities issued to purchasers may be fewer than, equal to, or, in some cases, greater than the number of shares purchased in the underlying operational business.

Periodic disbursements from the ongoing business may be received and allocated to the purchasers of the defined maturity equity investment. The disbursements may, in some instances, require recapitalization of the defined maturity equity investment due to certain equity events related to the underlying equity interest such as a new share issuance. Other events, such as a stock split, a reverse split, buyback of existing shares, share swaps, corporate restructuring, a merger, and/or an acquisition may also trigger disbursements or reallocation of shares.

The redemption value may be measured as a cash value. The operational results used to calculate the redemption value may include any known financial and/or operational metric, but in specific embodiments may include the book price per share and/or the cumulative change in book price per share of the underlying equity based on a recently released financial report. In some instances, the operational results may include a cumulative net income per share from operations between the issue date and the maturity date.

In another aspect, a system for pricing the redemption value of an investment vehicle includes a data storage device, a communications and application server, which includes at least one processor. The data storage device stores information describing a plurality of investment opportunities, each representing an underlying equity interest in an ongoing business. The communications and application server receives and processes on a processor instructions to select the underlying equities as a basis for classes of defined maturity equity investments such that each class of the defined maturity equity investments hold equity ownership rights to the selected underlying equities and each of the classes of defined maturity equity investments has an maturity date on which the respective defined maturity equity investments may be redeemed for a respective redemption value. The communications and application server also calculates an allocation of disbursements to each class of the defined maturity equity investment generated by the underlying equities and the respective redemption values of each class of the defined maturity equity investment, and calculates a redemption value for the defined maturity equity investment based on the operational results of the ongoing business between the issuance date and the maturity date of the defined maturity equity.

The respective maturity dates may be fixed dates subsequent to the issuance date, or, in other instances, dates based on a known time horizon. In some cases where multiple underlying equities are used as a basis for the defined maturity equity, the fixed dates are staggered such that the defined maturity equity includes a collection of investment vehicles, each maturing at different time horizons. The time horizons may be of any duration, but in specific embodiments include one, two, five, ten and/or twenty year horizons. The dates may be selected based on a calendar (e.g., end of quarter, end of year) or dates on which the underlying business releases financial results.

In some embodiments, the communications server receives the operational results of the ongoing business automatically and at a defined periodicity over an electronic network thus facilitating the automated calculation of the redemption value. The communications server may also, in some cases, receive, via an electronic network, instructions from a purchaser to purchase one or more of the defined maturity equity investments, and in response thereto, causes the purchase of shares in the ongoing business. The communication server may also receive information describing periodic disbursements from the ongoing business and the processor allocates a share of the disbursements to the purchaser of the defined maturity equity investment. The processor may, in turn, recapitalize the defined maturity equity investment based on equity events (e.g., stock splits, payment of dividends, etc.) related to the underlying equity interest.

In another aspect, the invention provides software in computer-readable form and stored on a physical medium for performing the methods described herein.

### BRIEF DESCRIPTION OF DRAWINGS

In the drawings, like reference characters generally refer to the same elements throughout the different views. Also, the drawings are not necessarily to scale, emphasis instead generally being placed upon illustrating the principles of the invention.

FIG. 1 is a block diagram of an environment in which the techniques described herein may be implemented according to various embodiments of the invention.

FIG. 2 is a flow chart depicting, in summary, a process for determining the composition and redemption value of an investment vehicle in accordance with various embodiments of the invention.

FIG. 3 is a schematic of a system that may be used to implement the investment vehicle and methods described herein in accordance with one embodiment of the invention.

### DETAILED DESCRIPTION

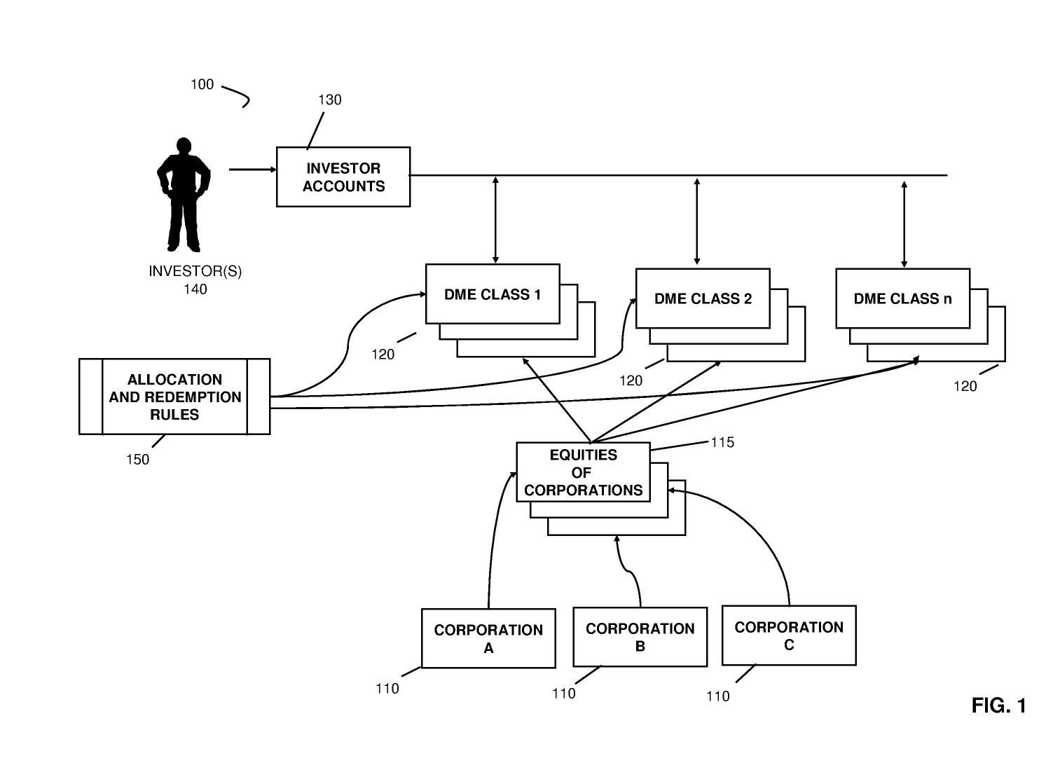

FIG. 1 depicts an exemplary environment 100 in which the techniques and systems described herein may be implemented to create, manage, distribute and redeem an investment product directed at accurately capturing the value of its underlying assets. The investment product, referred to herein as a defined maturity equity, or “DME” combines the benefits of purchasing equity in a known, ongoing business entity with the security of a known, fixed maturity date. Operating within the environment 100 are four general roles: a coordinator, a trustee/custodian, investors, and a liquidity provider. The coordinator acts as the issuing party that markets and sells the DMEs. The coordinator may be a securities dealer, a stock exchange, or other financial institution, a Special Purpose Vehicle Company, or, in some embodiments, the company issuing the underlying securities for the DME. The trustee/custodian, usually a well capitalized organization, retains the underlying securities on behalf of the issuer. The investors purchase the DMEs (or, as described in greater detail below the Residual Perpetual Equity, or “RPE”). The liquidity provider facilitates the purchase and liquidation of the underlying equities on behalf of the coordinator, although in some instances the coordinator can act as the liquidity provider.

In general summary, entities such as corporations 110 issue equities 115 in the form of stock to represent an ownership share in the corporation. To create the DME, some number of shares of the underlying equities 115 are purchased in the market. The shares may be shares of any publicly held entity such as a corporation or REIT. The shares are then deposited with a trust or custody as collateral for the DME. Based on the collateral, one or more classes of DMEs 120 are created. In some cases, each class may have a different issue date and/or maturity date, thus defining the DME lifespan. For example, all DMEs across a family of classes may issue on the same date, but class 1 may have a three year maturity, class 2 a five year maturity and so on. For each class, a number of DME shares are issued. The number of DME shares issued may be equal to the number of underlying shares held as collateral, it may be a fraction of the number of shares, or, in some cases, a multiple. The DMEs may then be purchased by investor accounts 130, owned by individual investors, institutional investors, mutual funds or other entities. During the lifetime of the DME, all the rights attached to the underlying equity are transferred to the DME holder, including voting rights and the right to receive dividends, with the exception that the DME holder does not have the freedom to sell the underlying equities. A set of allocation and redemption rules 150 are used to allocate and distribute funds to the DME holder during the DME lifespan and upon maturity. On the maturity date of a DME class, all or some fraction of the shares of the collateral equity are liquidated in the public market (the liquidation may start before the maturity date if necessary), according to the specified redemption rules, and the proceeds are used to pay the DME the redemption value, which is based on the term and the financial results of the company up to the maturity date. Normally, the DME holder will receive the minimal of the redemption value and the amount of proceeds obtained from the collateral liquidation. However, in some instances the rules may stipulate that a certain class of investors (such as those of the RPE class, discussed in detail below) are required to provide the shortfall between the liquidation proceeds and the computed redemption value.

More specifically, there are four primary attributes to a DME. The underlying equity (or equities) and the associated shareholder rights that are transferred to and provide the collateral for the DME, the maturity date for a particular DME or class of DMEs, interim changes or payouts, and a redemption value. Each are discussed in greater detail below.

Underlying Equity and Shareholder Rights

The DME can be based on a single equity (shares of stock from one company), a basket of equities (a selection of companies actively managed by an individual or quantitative model), or an established equity index (S&P 500, etc.). The underlying equities must be publicly listed and traded, such that the shares of the underlying equities may be purchased in the open market and are then deposited with a trustee or custodian as collateral. Normally, in the case of single equity, the number of the equity shares in the collateral trust corresponds exactly to the number of shares of DME issued, so that one share of DME receives the rights of one share equity, and redeemed in value corresponding to the per share operational results of the underlying equity. In some instances, however, over collateralization can be used so that more shares of equities are purchased than the DME issued. In such case, higher proceeds can be raised on the maturity date during collateral liquidation. In each case, the DME classes inherit all or some partial share of the shareholder's rights of its underlying equity or equities. The exact set of rights attached to each DME class is specified prior to the issuance.

Maturity Date

The maturity date can be any date in the future. In most instances, certain maturity dates are selected as the most traded benchmarks, similar to the maturity dates in the bond markets. One unique facet of the DME is that its maturity date is preferably a date closely following the financial reporting dates of the underling equity. In some instances, maturity dates may be allowed to change to a new date after the issuance of the DME when certain conditions are met or certain events take place. For example, if the market price of the underlying equity has fallen below some percentage, such as 105%, of the current value of the redemption value of a DME class, then that DME class is immediately redeemed with the liquidation of the corresponding underlying equity. The redemption value under an early redemption event can be stipulated in a similar as it is on a normal maturity date, or, in some cases, using different redemption rules.

Interim Changes and Payout

During the period between the issuance date and the maturity date of DME, changes, actions and distributions made to the collateral equities in the trust will be received by the DME as specified in its term sheet. The inherited changes may include share splits, share swap, M&A transactions, and general restructuring. The actions may include proxy votes, new shares subscription, etc. The distributions to the DME owners may include cash and/or share dividends.

Changes that constitute a liquidation event to the underlying equity are treated pursuant to the liquidation rules. For example, even though the DME owner does not have the freedom to liquidate the underlying equity in the market, in certain situations, for example when an underlying business makes an offer to tender its shares, the DME owner can have the voting right to accept or reject the offer. If the DME owner accepts the offer, the proceeds received may not be distributed entirely to DME, as such a liquidation event may be deemed an early redemption event, in which case, the DME receives only the Redemption Value stipulated for such an event.

Redemption Value

On the maturity date, or on the date of an early redemption event, the DME is redeemed at the redemption value. The redemption value is unknown at the issuance date, and is computed at the redemption date based on a redemption function. The redemption function is structured so that the redemption value represents observable operational results already occurred during the issuance period of the DME. In some instances, the redemption value of DME is capped by the proceeds obtained from liquidating the equities in the collateral trust. Described below are two broad classes of possible redemption functions—a redemption value reflecting the outstanding shareholder equity at the maturity date, and a redemption value reflecting the amount of shareholder equity generated during the issuance period of the DME.

Outstanding Shareholder Equity at Maturity Date

Shareholder's Equity is reported in the balance sheet in the quarterly financial report filed by a public company with the Securities and Exchange Commission, or some other governing agency. Other common names known for the Shareholder's Equity are “Book Value” or “Net Assets.” Another entry in the quarterly financial report, referred to as the “Change of Shareholder's Equity” provides further details of changes to the Shareholder's Equity from quarter to quarter. As a first example of using Outstanding Shareholder Equity at Maturity Date as the redemption value, the publicly reported and audited Shareholder's Equity or Book Value is used to determine the redemption value. Thus, the redemption value is equal to the book value per share (the book price) of the equity at the maturity date based on the latest available financial report for the issuing company. If the total number of outstanding equity shares of the company changes during the interim due to new issue, split, buyback, merger or acquisition, the shares of DME adjust accordingly based on the shareholder rights held by the DME shares. For example, at the issuance, 1 share of the DME corresponds to 1 share of equity X. Subsequently, the equity undergoes 1 to 2 share split. Accordingly, 1 share of the DME now corresponds to 2 shares of equity X.

Variations on the redemption function described above may be implemented to satisfy the demand of different investors. In one example, the volatile component of the book price may be eliminated by removing changes made to the book price from the Other Comprehensive Income. For example if the book price at the issuance date is $10 and $20 on the maturity date, yet if the cumulative Other Comprehensive Income (such as foreign currency translation) per share during the interim is $3, then the adjusted book price on maturity is $20-$3=$17.

In another example, in order to minimize the impact of an artificial or drastic change in an accounting treatment or policy, the amortization rate of capital investment may be fixed, rather than subject to periodic revision by the management. As a result, if the book price is dramatically reduced because the management has made a sudden large write off on a capital investment made in the past, the write off may be excluded from the change of the book price and replaced by a fixed amortization amount.

In yet another example, investors may wish to eliminate the effect of the company's buyback activities on its book price for the purpose of computing the redemption value. When a company buys back its own shares, the book value of the company is reduced by the amount of proceeds spent on the buyback. In such cases, provisions can be made such that whenever the company buys back shares, an adjustment is made to the book price to cancel out the effect of the buyback. Or alternatively, such buyback can trigger partial early redemption under which a certain number of DME shares are redeemed such that an amount of proceeds is raised that equals the reduction in book value that resulted from buyback. This is done by liquidating corresponding number of shares of the underlying equity and the proceeds are paid to the DME owner as partial redemption. As a result, the DME owner is now entitled to fewer shares than prior to the buyback.

Different redemption functions may be suitable for different industries, sectors, types of company, investor demands or economic conditions, as no one redemption function may be applicable in every case. For example, the redemption function based solely on book price may be more appropriate in cases in which the DME is based on a basket of equities or an equity index than certain single equity because of dilution of the potential accounting effects among the various component equities. This redemption function may also be more appropriate for manufacturing companies than for banks because banks typically have significant exposure to financial assets for which the valuation of their book value is more subjective and volatile as compared to assets of manufacturing companies.

Redemption Value as a Function of the Amount of Shareholder Equity Generated During the DME Lifespan

Another approach to calculating the redemption value is to base it on cumulative operational results realized during the issuance period of the DME. This may include, but is not limited to, the cumulative results of change in Total Shareholder's Equity, or the Net Income, or the Cash Flow. The above quantities can be utilized with various adjustments to suit specific demands. For example, Net Income from Continuous Operation may be used as the basis for the Redemption Value rather than Net Income. Free Cash Flow (defined as the EBITA—Capital Expenditure) may also be used rather than Cash Flow. In yet another example, the redemption value may be defined as the cumulative Net Income from Operation before Amortization and Depreciation minus the Long Term Debt Amortization.

In the examples above, the DME is issued solely from the collateral equity or equities. In some instances, however, the residual of the collateral may be issued as another separate security, referred to herein as a Residual Perpetual Equity, or “RPE”. By definition, the RPE has the residual rights of the collateral equities after the rights have been taken by the DME. In the case that the shares of DME correspond to all the shares of the collateral equity, the RPE has no equity rights before the maturity date. On the maturity date or the early redemption date, the RPE receives the residual liquidation value, if any remaining, of the collateral equity after the DMEs are paid in full in their respective Redemption Values. In one embodiment, the RPE owner receives all the collateral equities on the maturity date and in exchange pays the DME owner the redemption value of the DME security. In such embodiment, no liquidation of the underlying equities is required on redemption.

In addition to the structures of the DME and the RPE described above, a variety of additional structures can be customized to tailor to specific investor demands, risk profiles and returns. As one example, out of the same collateral equity, two DMEs of different maturity dates plus one RPE can be issued. For example, the collateral may includes 100 shares of equity X. From the collateral, 50 shares of DME maturing in 5 years, 50 shares of DME maturing in 10 years, and one share of RPE are issued. During the first 5 years, both the 5 year DME and the 10 year DME receive dividends based on 50 shares of equity X. On the maturity date of the 5 year DME, just enough shares of equity X are liquidated to pay for the redemption value of the 5 year DME and retire the security. For example, assume 30 shares of the equity are sold to pay out the 5 year DME. Then, between years 5 and 10, the 10 year DME continues to receive the dividends from 50 shares of collateral equities. The dividends of the additional 20 shares remaining in the collateral trust are paid instead to the RPE. On the maturity date of the 10 year DME, the residual 70 shares of equity X are liquidated and the proceeds pay for the DME up to the redemption value. The residual proceeds are then paid to the RPE. As another example, the underlying equity rights may be split among different DME classes. For example, one DME class may receive only the dividend, and another DME class receives the redemption value.

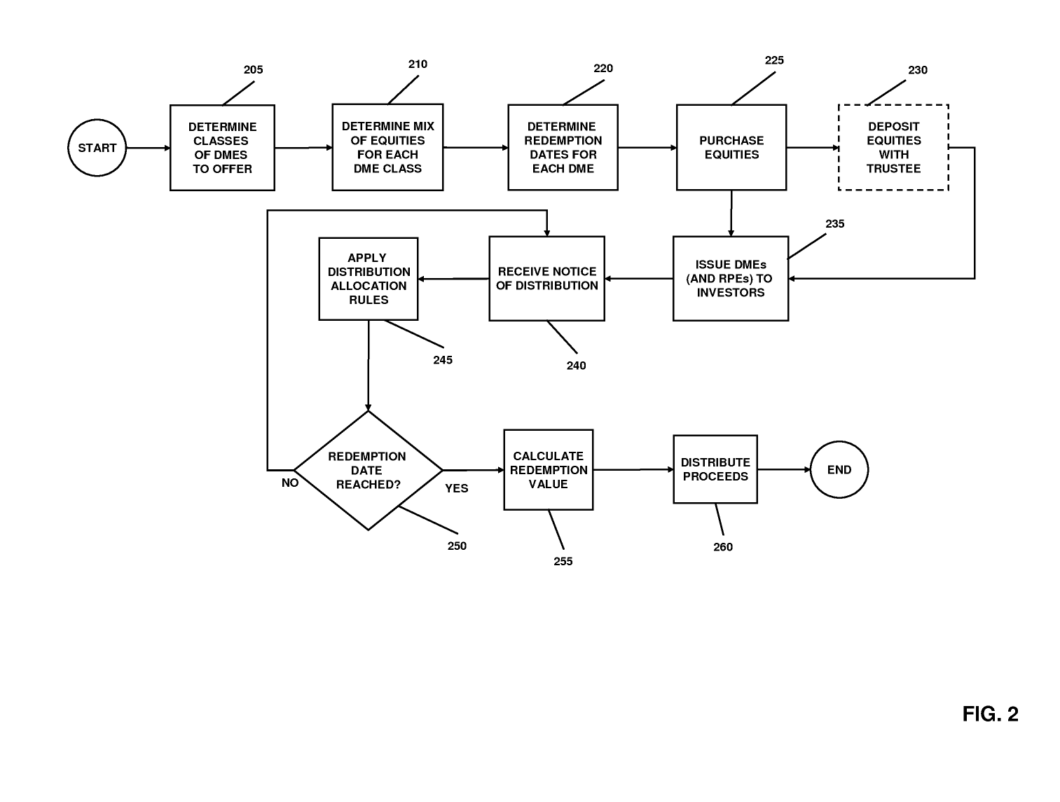

The above description provides the major structural components of the DME and RPE. FIG. 2 illustrates an exemplary workflow of the method for issuance, allocation and redemption of the DME up through the maturity date.

As an initial step. the coordinator determines the classes of DMEs and or RPEs they wish to provide, based on the equities available in the market, the time horizons deemed appropriate, and/or demand from investors (STEP 205). As noted above, the DMEs may include a single entity (e.g., shares of General Motors), multiple entities (e.g., shares of Apple, Google and Microsoft) or based on an index (e.g., the S&P 500 index). Furthermore, each class may have a different time horizon, which determines its maturity date. For example, one class may have a one year maturity date, whereas another class (having the same or possibly a different equity mix) may have a two year maturity date. In some instances, the coordinator may design each DME using a strategically determined pool of equities and/or weighted allocations. Based on the market and general research, the coordinator determines the mix of equities for each DME class (STEP 210) and the redemption dates for each DME (STEP 220). The coordinator then purchases the equities (STEP 225) and (alternatively) deposits them with the trustee or custodian (STEP 230). The coordinator may purchase the shares using its own capital, or the capital committed by the DME and or the RPE investors. The coordinator then issues the DMEs to investors (STEP 235) via one or more distribution and sales channels. In some embodiments, the coordinator may also issue RPEs based on the issued DMEs.

The coordinator provides the investors with the full terms of the DME and RPE, including the maturity date, underlying equities and the rights attached to the DME and RPE, the redemption function, and any required mechanisms during the life of the securities. The mechanisms may include but are not limited to a collateral accumulation mechanism, an additional issuance mechanism, an interim auditing mechanism, the liquidation mechanism, and the re-assembly mechanism, as explained in greater detail below.

The collateral accumulation mechanism is typically specified before the DME is issued to the investors if the issuer/coordinator requires the investors to place a limited order on the DME and/or the RPE, and requires the investors to forward the entire proceeds needed for executing the limited order to the issuer prior to the issuance. This mechanism specifies how the proceeds will be used to accumulate the collateral shares, under what conditions the DME and RPE will be issued, and under what conditions the proceeds will be returned to the investors without the issuance of the DME and RPE shares. The additional issuance mechanism establishes the condition(s) under which additional issuance of shares of the same DME and RPE may be executed and the methods through which additional collateral equities will be purchased and deposited into the trust.

Once issued, the processes related to interim auditing, monitoring, distribution and reporting occur. In some implementations, an auditor or servicer is engaged to enforce the terms specified in the term sheet for the DME and the RPE. The auditor is responsible for reviewing, analyzing and tracking the publicly available financial data reported by a company and relating the data to the terms of the DME and the RPE based on its equity shares. The auditor is further responsible to keep track of upcoming corporate actions, receiving and processing notices of distributions or other corporate events (STEP 240) and providing notice to the DME and the RPE investors relating to such actions. The auditor applies the relevant distribution and allocation rules (STEP 245) to determine the proper action on each DME and RPE class related to the underlying equities. The auditor may compute and update DME investors with the current Redemption Values of the DMEs based on the publicly disclosed financial data from the company on a quarterly basis. The auditor may further produce periodic reports to the investors for updates on the relevant information on the DMEs and/or RPEs they own. The specific roles and responsibilities of the auditor, and the communication and reports that the auditor is required to provide, and if necessary the conditions and methods for replacing the current auditor by another one, are specified in the interim auditing mechanism.

During the lifetime of the DME, the coordinator determines if the DME has reached its maturity date (STEP 250). If not, the auditor continues to apply the distribution and allocation rules after each corporate event. If, however, the maturity date has been reached (or is pending) the coordinator, via the liquidity provider, liquidates the collateral equities in the collateral trust account and calculates the redemption value (STEP 255). The proceeds are then applied to the DME investors and distributed (STEP 260) until the redemption value is paid in full or until the proceeds are exhausted. Alternatively, in cases in which an RPE security has been issued, the RPE investor can alternatively provide the proceeds needed to pay the redemption value for the DME, and receive all the collateral equities in the trust account. In the case that the liquidation of the collateral trust is required, a liquidation mechanism is specified before the issuance of the DME. The liquidation mechanism specifies the time prior to the maturity date to commence the liquidation, the amount of shares to be liquidated per day, and other conditions and rules on the liquidation process. The liquidation mechanism may further stipulate the liquidation process under an early redemption event.

A re-assembly mechanism can be set up to facilitate secondary trading of DME and RPE. Under such mechanism, the coordinator, through the liquidity provider, can buy back the DME and RPE classes, re-assemble and liquidate the underlying equities.

It is understood that the methods and systems described below may contain software and hardware connected to the Internet via a network. Computing devices are capable of communicating with each other via the Internet, and it should be appreciated that the various functionalities of the components may be implemented on any number of devices.

A communications network generally connects the computing devices to each other and to components within the systems described herein. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), and so on.

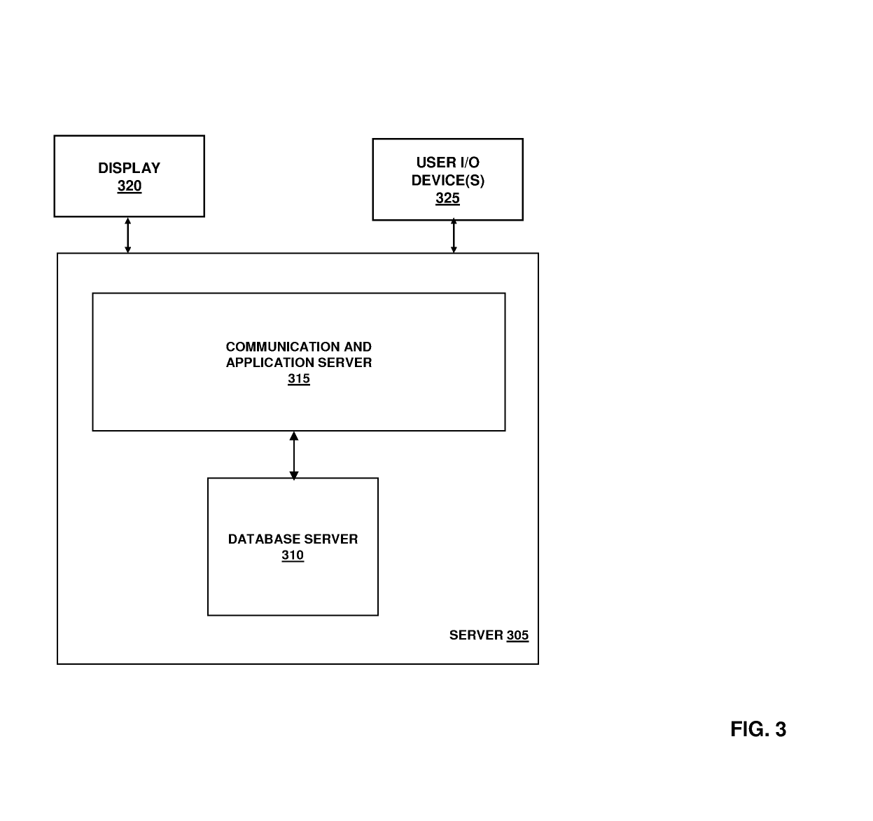

Referring to FIG. 3, those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide data storage and management functionality, for example as a database management system or database server 310 which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed application server 315 having one or more processors in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through one or more user interface devices 325 that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices 320 may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Although internal components of the computer are not shown, those of ordinary skill in the art will appreciate that such components and the interconnections are well known. Accordingly, additional details concerning the internal construction of the computer need not be disclosed in connection with the present invention.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

What is claimed is:

1. A computerized method for allocating disbursements from and pricing the redemption value of an investment, the method comprising the steps of:
identifying a plurality of investment opportunities, each opportunity represented by an underlying equity ownership interest in an ongoing business;
selecting a number of one or more of the underlying equities as a basis for a plurality of classes of defined maturity equity investments such that (i) each class of the defined maturity equity investments holds exercisable equity ownership rights to the selected underlying equities, and (ii) each class of the defined maturity equity investments has a respective issuance date and maturity date on which the respective classes of defined maturity equity investments may be redeemed for a respective redemption value;
retrieving from a data storage device a set of allocation and redemption processing rules for calculating allocation of disbursements to each class of the defined maturity equity investment generated by the underlying equities and the respective redemption values of each class of the defined maturity equity investment; and
executing the allocation processing rules on a processor to calculate (i) disbursement amounts for each class of the defined maturity equity investments and (ii) the redemption value for the defined maturity equity investments, at least one of each being based at least in part on operational results between the issuance date and the respective maturity date of the defined maturity equity of the ongoing businesses associated with the respective underlying equities.

2. The method of claim 1 wherein the redemption value is provided as cash.

3. The method of claim 1 wherein the underlying equity interest in the ongoing business comprises stock traded on an open marketplace.

4. The method of claim 1 wherein the maturity date comprises a fixed date subsequent to the issuance date.

5. The method of claim 4 wherein the fixed dates for each class are staggered such that the defined maturity equity comprises a collection of investment vehicles, each maturing at different time horizons.

6. The method of claim 5 wherein the time horizons comprise one or more of a one year horizon, a two year horizon, a five year horizon, a ten year horizon and a twenty year horizon.

7. The method of claim 4 wherein the fixed dates correspond to dates at which the ongoing business releases financial results.

8. The method of claim 1 wherein the defined maturity equity investment comprises a single equity.

9. The method of claim 1 wherein the defined maturity equity investment comprises a plurality of equities.

10. The method of claim 1 further comprising receiving, via an electronic network, instructions from a purchaser to purchase one or more of the defined maturity equity investments, and in response thereto, purchasing shares in the ongoing business and depositing the purchased shares with a third party trustee.

11. The method of claim 10 further comprising issuing shares of the defined maturity equity investment equal to the number of purchased shares.

12. The method of claim 10 further comprising issuing shares of the defined maturity equity investment greater than the number of purchased shares.

13. The method of claim 10 further comprising issuing shares of the defined maturity equity investment fewer than the number of purchased shares.

14. The method of claim 10 further comprising receiving periodic disbursements from the ongoing business and distributing a share of the disbursements to the purchaser of the defined maturity equity investment.

15. The method of claim 10 further comprising recapitalizing the defined maturity equity investment based on one or more equity events related to the underlying equity interest.

16. The method of claim 1 wherein the operational results comprises a book value per share of the underlying equity based on a released financial report.

17. The method of claim 1 wherein the operational results comprises a cumulative net income per share from operations between the issue date and the maturity date.

18. The method of claim 1 wherein the operational results are further adjusted by adding the Amortization and Depreciation, and subtracting a value reflecting the amortized debt load of the company.

19. The method of claim 1 further comprising updating the allocation and redemption processing rules to include instructions for allocating residual disbursements above the disbursement amounts allocated to each class of the defined maturity equity investments to separate residual perpetual entity investments.

20. A system for pricing the redemption value of an investment vehicle, the system comprising:
a data storage device for storing information describing a plurality of investment opportunities, each representing an underlying equity interest in an ongoing business;
a communications and application server for receiving and processing on a processor instructions to (a) select one or more of the underlying equities as a basis for a plurality of classes of defined maturity equity investments such that (i) each class of the defined maturity equity investments holds exercisable equity ownership rights to the selected underlying equities and (ii) each class of the defined maturity equity investments has a respective issuance date and maturity date on which the respective classes of defined maturity equity investments may be redeemed for a respective redemption value; (b) calculate an allocation of disbursements to each class of the defined maturity equity investment generated by the underlying equities and the respective redemption values of each class of the defined maturity equity investment; and (c) calculate a redemption value for the defined maturity equity investment based at least in part on operational results of the ongoing business between the issuance date and the maturity date of the defined maturity equity.

21. The system of claim 20 wherein the underlying equity interest in the ongoing business comprises stock traded on an open marketplace.

22. The system of claim 20 wherein the respective maturity dates comprise fixed dates subsequent to the issuance date.

23. The system of claim 22 wherein the fixed dates are staggered such that the defined maturity equity comprises a collection of investment vehicles, each maturing at different time horizons.

24. The system of claim 20 wherein the communications and application server further receives the operational results of the ongoing business automatically and at a defined periodicity over an electronic network thus facilitating the automated calculation of the redemption value.

25. The system of claim 20 wherein the communications and application server further receives, via an electronic network, instructions from a purchaser to purchase one or more of the defined maturity equity investments, and in response thereto, causes the purchase of shares in the ongoing business.

26. The system of claim 20 wherein the communication server receives information describing periodic disbursements from the ongoing business and the processor allocates a share of the disbursements to the purchaser of the defined maturity equity investment.

27. The system of claim 20 wherein the processor recapitalizes the defined maturity equity investment based on one or more equity events related to the underlying equity interest.

28. Anon-transitory article of manufacture having computer-readable program portions embodied thereon for pricing the redemption value of an investment vehicle, the article comprising computer-readable instructions for:
identifying a plurality of investment opportunities, each opportunity represented by an underlying equity ownership interest in an ongoing business;
selecting a number of one or more of the underlying equities as a basis for one or more a plurality of classes of defined maturity equity investments such that (i) each class of the defined maturity equity investments hold equity ownership rights to the selected underlying equities, and (ii) each class of the defined maturity equity investment has a respective issuance date and maturity date on which the respective classes of defined maturity equity investments may be redeemed for a respective redemption value;
retrieving from a data storage device a set of allocation and redemption processing rules for calculating allocation of disbursements to each class of the defined maturity equity investment generated by the underlying equities and the respective redemption values of each class of the defined maturity equity investment; and
executing the allocation processing rules on a processor to calculate (i) disbursement amounts for each class of the defined maturity equity investments and (ii) the redemption value for at least one of the defined maturity equity investments based at least in part on operational results between the issuance date and the respective maturity date of the defined maturity equity of the ongoing businesses associated with the respective underlying equities.
